(19) United States
(12) Patent Application Publication
(10) Pub. No.: US 2026/0226994 A1
(43) Pub. Date: Aug. 6, 2026

(54) ROTARY VALVE

(71) Applicant: SHIMADZU CORPORATION, Kyoto (JP)

(72) Inventor: Ryota KANAMARU, Kyoto (JP)

(73) Assignee: SHIMADZU CORPORATION, Kyoto (JP)

(21) Appl. No.: 19/442,823

(22) Filed: Jan. 7, 2026

(30) Foreign Application Priority Data
Feb. 5, 2025 (JP) 2025-017299

(51) Int. Cl. F16K 31/04; G01N 30/20

(52) U.S. Cl. CPC F16K 31/043; G01N 30/20; G01N 2030/202

(57) ABSTRACT

A rotary valve includes: a motor; a rotor shaft that is axially rotated by the motor; a housing that accommodates the rotor shaft in an internal space thereof; a stator fixed to the housing on a distal end side of the rotor shaft; a rotor that is held at the distal end of the rotor shaft and rotates together with the rotor shaft; a bearing that is interposed between an inner peripheral surface of the housing and an outer peripheral surface of the rotor shaft, supports the rotor shaft, and engages with the rotor shaft in an axial direction of the rotor shaft; and an elastic member that is provided in the internal space of the housing so as to urge the rotor shaft toward the stator side via the bearing, independently of the rotation of the rotor shaft.

### TECHNICAL FIELD

The present invention relates to a rotary flow path switching valve (hereinafter referred to as a rotary valve) used in an analysis apparatus such as a liquid chromatograph.

### BACKGROUND ART

In analysis apparatuses such as liquid chromatographs, rotary valves are often used as valves for switching flow path connections. In a rotary valve, a rotor is held at the tip of a rotor shaft that is rotated by a motor, and the rotor shaft is urged toward the stator side using the elastic force of an elastic member such as a coil spring, thereby pressing the rotor against the stator to ensure surface pressure, and thereby obtaining high pressure resistance performance (see Patent Literature 1).

### CITATION LIST

### Patent Literature

[Patent Literature 1] International Publication No. 2019/188011

### SUMMARY OF INVENTION

### Technical Problem

In a conventional rotary valve, the elastic member that urges the rotor toward the stator side generally rotates together with the rotor shaft. To ensure smooth rotation of the rotor shaft, a combination of multiple bearings, such as not only a radial bearing that

supports the rotor shaft but also a thrust bearing that supports the elastic member, is often used. However, the bearings themselves have complex shapes requiring precision, and require interfering components such as spacers, which increases the number of components. An increase in the number of components not only leads to an increase in product dimensions and manufacturing costs, but also risks accumulation of dimensional tolerances of the components, which can deteriorate the positional accuracy of the rotor. If the positional accuracy of the rotor deteriorates, misalignment may occur between the grooves of the rotor and the holes of the stator, increasing dead volume and causing carry-over or diffusion, which can adversely affect analysis results.

The present invention has been made in view of the above problems, and an object thereof is to reduce the number of components in a rotary valve.

### Solution to Problem

A rotary valve according to the present invention includes: a motor; a rotor shaft that is axially rotated by the motor; a housing that accommodates the rotor shaft in an internal space thereof; a stator fixed to the housing on a distal end side of the rotor shaft; a rotor that is held at the distal end of the rotor shaft and rotates together with the rotor shaft; a bearing that is interposed between an inner peripheral surface of the housing and an outer peripheral surface of the rotor shaft, supports the rotor shaft, and engages with the rotor shaft in an axial direction of the rotor shaft; and an elastic member that is provided in the internal space of the housing so as to urge the rotor shaft toward the stator side via the bearing, independently of the rotation of the rotor shaft.

### Advantageous Effects of Invention

According to the rotary valve of the present invention, the bearing, which is interposed between the inner peripheral surface of the housing and the outer peripheral surface of the rotor shaft and supports the rotor shaft, engages with the rotor shaft in the axial direction of the rotor shaft. The elastic member is provided so as to urge the rotor shaft toward the stator side via the bearing, independently of the rotation of the rotor shaft. Therefore, the elastic member does not rotate with the rotation of the rotor shaft, and a bearing to support the elastic member is unnecessary. This makes it possible to use only one bearing to achieve smooth rotation of the rotor shaft, and the number of components of the rotary valve can be reduced.

### BRIEF DESCRIPTION OF DRAWINGS

FIG. 1 is a partial cross-sectional view showing one embodiment of a rotary valve.

FIG. 2 is a partial cross-sectional view showing a state in which a motor is removed in the same embodiment.

### DESCRIPTION OF EMBODIMENTS

Hereinafter, an embodiment of the rotary valve according to the present invention will be described with reference to the drawings.

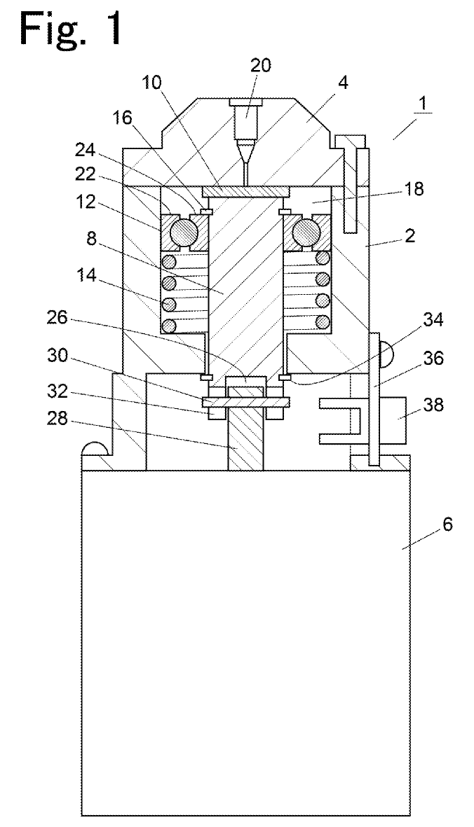

As shown in FIG. 1, a rotary valve 1 mainly includes a housing 2, a stator 4, a motor 6, a rotor shaft 8, a rotor 10, a bearing 12, and an elastic member 14.

The housing 2 is an integral member with a substantially hollow cylindrical shape having an open distal end (upper end in the figure). The stator 4 is fixed to the distal end of the housing 2 by bolts, and the motor 6 is fixed to the proximal end (lower end in the figure) of the housing 2 by bolts. That is, the stator 4 and the motor 6 are fixed to a common single member (the housing 2). Therefore, the rotary valve 1 has a structure in which the stator 4 and the motor 6 are fixed to the integral housing 2, resulting in a small number of components and easy assembly.

The stator 4 is provided with a plurality of piping connection parts 20 for connecting piping. Note that only one piping connection part 20 is shown in the figure. The piping connection part 20 communicates with a surface (lower surface in the figure) on the internal space 18 side of the housing 2 via a flow path. The rotor 10 rotates while in contact with the lower surface of the stator 4, thereby switching the mutual connection state of the plurality of pipes connected to the stator 4.

The rotor shaft 8 is disposed in the internal space 18 of the housing 2 with its distal end (upper end in the figure) facing the stator 4 side and its proximal end (lower end in the figure) facing the motor 6 side. The rotor shaft 8 is axially rotated by the motor 6. The rotor 10 is held at the distal end of the rotor shaft 8 and rotates with the rotation of the rotor shaft 8.

The bearing 12 is interposed between the outer peripheral surface of the rotor shaft 8 and the inner peripheral surface of the housing 2, and supports the rotor shaft 8 to stabilize its rotation. In this embodiment, the bearing 12 is a ball bearing having an outer ring 22 and an inner ring 24. The outer ring 22 of the bearing 12 has an outer diameter slightly smaller than the inner diameter of the housing 2, and the inner ring 24 of the bearing 12 has an inner diameter slightly larger than the outer diameter of the rotor shaft 8. Note that the bearing 12 is not necessarily a ball bearing and may be a sliding bearing.

A protruding portion 16 that protrudes radially outward from the outer peripheral surface is provided at the distal end portion of the rotor shaft 8. In this embodiment, the protruding portion 16 is configured by a C-type retaining ring attached to a groove provided on the outer peripheral surface of the rotor shaft 8. However, the present invention is not limited to this, and the protruding portion 16 may be integral with the rotor shaft 8. Note that when the protruding portion 16 is formed integrally with the rotor shaft 8, it is necessary to perform a grinding process after machining the rod to form the protruding portion 16. However, if the protruding portion 16 is realized by a retaining ring, the rotor shaft 8 can be created by simply forming a groove in a pre-ground rod (a bar-shaped member before being processed into the rotor shaft 8) and then fitting the retaining ring, which can reduce costs.

The bearing 12 is disposed on the proximal end side of the rotor shaft 8 relative to the protruding portion 16, and the inner ring 24 of the bearing 12 engages with the protruding portion 16. That is, the bearing 12 engages with the rotor shaft 8 only in the axial direction of the rotor shaft 8 (upward direction in the figure).

The elastic member 14 is disposed in a compressed state on the proximal end side of the rotor shaft 8 relative to the bearing 12 in the internal space 18 of the housing 2, so as to urge the bearing 12 toward the stator 4 side. When the bearing 12 is urged toward the stator 4 side by the elastic member 14, the rotor shaft 8, which is engaged by the bearing 12 and the protruding portion 16, is urged toward the stator 4 side, and the rotor 10 held at the distal end of the rotor shaft 8 is pressed against the stator 4. This ensures sealability between the stator 4 and the rotor 10. Note that in this embodiment, the rotor 10 is in direct contact with the stator 4, but the present invention is not limited to this, and another member fixed to the stator 4 side may be interposed between the stator 4 and the rotor 10.

The elastic member 14 is in direct contact only with the outer ring 22 of the bearing 12. In other words, the elastic member 14 contacts the bearing 12 without interfering with the inner ring 22 of the bearing 12, and the elastic member 14 does not rotate with the rotation of the rotor shaft 8. Therefore, a thrust bearing for supporting the elastic member 14 and allowing it to rotate smoothly is unnecessary. In this way, since the only component that interferes with the rotation of the rotor shaft 8 is the inner ring 24 of the bearing 12, members such as bearings for smoothing the rotation of components other than the rotor shaft 8 are unnecessary, which contributes to reducing the number of components in the rotary valve 1.

Note that in this embodiment, the elastic member 14 is a coil spring having an outer diameter such that it contacts only the outer ring 22 of the bearing 12. However, the present invention is not limited to this, and any member capable of urging the bearing 12, such as a leaf spring, can be used as the elastic member 14.

Furthermore, the elastic member 14 does not necessarily have to be in direct contact with the outer ring 22 of the bearing 12, and the elastic member 14 may urge the bearing 12 toward the stator 4 side via a member that contacts the outer ring 22 without interfering with the inner ring 24 of the bearing 12.

The above is an explanation for the case where the bearing 12 is a ball bearing. However, when the bearing 12 is a sliding bearing, the bearing 12 itself does not rotate with the rotation of the rotor shaft 8, so the elastic member 14 in contact with the bearing 12 also does not rotate. As in the case of the ball bearing, a thrust bearing for supporting the elastic member 14 and allowing it to rotate smoothly is unnecessary.

The central axis of the drive shaft 28 of the motor 6 and the central axis of the rotor shaft 8 are aligned with each other, and the motor 6 is fixed to the integral housing 2. A fitting structure that engages with each other is provided at the distal end portion of the drive shaft 28 of the motor 6 and the proximal end portion of the rotor shaft 8. The drive shaft 28 of the motor 6 and the rotor shaft 8 engage with each other only in the rotational direction by this fitting structure. In this embodiment, the fitting structure is configured by a pin 30 attached to the distal end portion of the drive shaft 28 of the motor 6, and a recess 26 and a groove 32 provided at the proximal end of the rotor shaft 8. The pin 30 penetrates the drive shaft 28 in a direction perpendicular to the axial direction of the drive shaft 28 (left-right direction in the figure). The distal end portion of the drive shaft 28 of the motor 6 is inserted into the recess 26 at the proximal end of the rotor shaft 8, and the pin 30 attached to the drive shaft 28 is fitted into the groove 32. The width of the groove 32 is substantially the same as the outer diameter of the pin 30. Thereby, when the drive shaft 28 of the motor 6 rotates, the pin 30 pushes the inner side surface of the groove 32 at the proximal end portion of the rotor shaft 8, rotating the rotor shaft 8.

Note that the fitting structure is not limited to the above, and any structure may be used as long as it engages the drive shaft 28 and the rotor shaft 8 only in the rotational direction. For example, the distal end portion of the drive shaft 28 of the motor 6 may have a shape such as a gear, and the recess 26 of the rotor shaft 8 may have a shape that fits with the distal end portion of the drive shaft 28. As described above, since the drive shaft 28 of the motor 6 and the rotor shaft 8 have a simple structure that engages only in the rotational direction by the fitting structure, components such as a coupling for connecting the drive shaft 28 and the rotor shaft 8 are unnecessary, contributing to a reduction in the number of components.

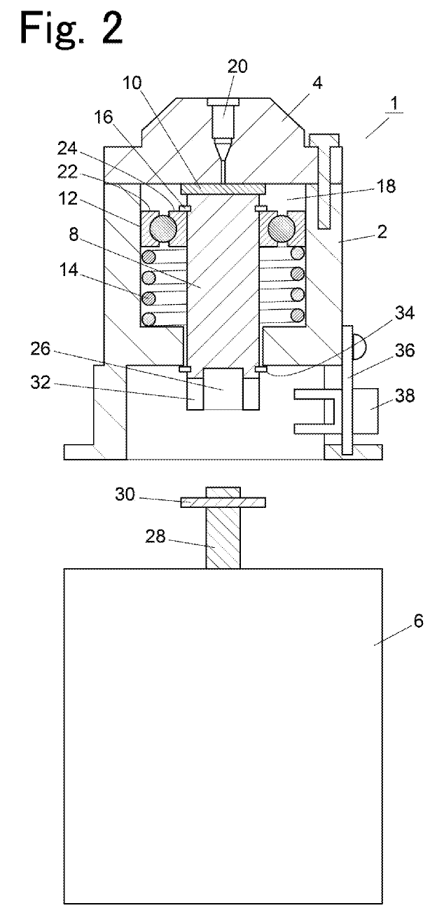

Furthermore, this structure is one in which the drive shaft 28 of the motor 6 and the rotor shaft 8 do not interfere with each other in the axial direction, as shown in FIG. 2. If the drive shaft 28 of the motor 6 and the rotor shaft 8 are also fixed in the axial direction, when the stator 4 is removed from the housing 2 while the motor 6 is fixed to the housing 2, the rotor shaft 8 is pushed in the direction opposite to the motor 6 (upward direction in the figure) by the elastic force of the elastic member 14, which may apply a load to the drive shaft 28 and affect the performance of the motor 6. In this embodiment, since the drive shaft 28 of the motor 6 and the rotor shaft 8 do not interfere with each other in the axial direction, no load is applied to the drive shaft 28 of the motor 6 even when the stator 4 is removed from the housing 2.

In this embodiment, a retaining ring 34 for preventing detachment is attached to the outer peripheral surface of the proximal end portion of the rotor shaft 8, preventing the rotor shaft 8 from popping out to the side opposite the motor 6 due to the elastic force of the elastic member 14 when the stator 4 is removed from the housing 2.

A rotation sensor 38 for detecting the rotational position of the drive shaft 28 of the motor 6 is attached to the housing 2 via a mounting plate 36. This eliminates the need to provide a separate mechanism from the housing 2 for detecting the rotational position of the drive shaft 28 of the motor 6, contributing to a reduction in the number of components.

The embodiment described above is merely one example of the embodiment of the rotary valve according to the present invention. Embodiments of the rotary valve according to the present invention are as follows.

One embodiment of the rotary valve according to the present invention includes: a motor; a rotor shaft that is axially rotated by the motor; a housing that accommodates the rotor shaft in an internal space thereof; a stator fixed to the housing on a distal end side of the rotor shaft; a rotor that is held at the distal end of the rotor shaft and rotates together with the rotor shaft; a bearing that is interposed between an inner peripheral surface of the housing and an outer peripheral surface of the rotor shaft, supports the rotor shaft, and engages with the rotor shaft in an axial direction of the rotor shaft; and an elastic member that is provided in the internal space of the housing so as to urge the rotor shaft toward the stator side via the bearing, independently of the rotation of the rotor shaft.

In a first aspect of the one embodiment, the bearing is a ball bearing having an inner ring and an outer ring, the inner ring of the ball bearing and the rotor shaft engage in the axial direction of the rotor shaft, and the elastic member is provided so as to be in direct contact only with the outer ring of the ball bearing and urge the ball bearing toward the stator side.

In a second aspect of the one embodiment, the rotor shaft includes a protruding portion at its distal end portion that protrudes radially outward from the outer peripheral surface, and the bearing engages with the rotor shaft by contacting the protruding portion. This second aspect can be combined with the first aspect.

In a third aspect of the one embodiment, the protruding portion is a retaining ring attached to the outer peripheral surface of the rotor shaft. This third aspect can be combined with the first aspect and/or the second aspect.

In a fourth aspect of the one embodiment, the housing is an integral structure, and both the motor and the stator are fixed to the housing. This fourth aspect can be combined with the first aspect, the second aspect, and/or the third aspect.

In the fourth aspect, the central axis of the drive shaft of the motor and the central axis of the rotor shaft may be aligned with each other.

In the above case, a fitting structure that engages in the rotational direction by fitting with each other may be provided at the distal end portion of the drive shaft of the motor and the proximal end portion of the rotor shaft, and the drive shaft of the motor and the rotor shaft may engage with each other only in the rotational direction by the fitting structure.

Furthermore, in the above case, the fitting structure may include a pin that penetrates the distal end portion of the drive shaft of the motor perpendicularly to the axial direction, and a groove provided in the proximal end portion of the rotor shaft into which the pin is fitted.

### REFERENCE SIGNS LIST

1 Rotary Valve

2 Housing

4 Stator

6 Motor

8 Rotor Shaft

10 Rotor

12 Bearing

14 Elastic Member

16 Protruding portion

18 Internal space of housing

20 Piping connection part

22 Outer ring of bearing

24 Inner ring of bearing

26 Recess

28 Drive shaft

30 Pin

32 Groove

34 Retaining ring

36 Mounting plate

38 Rotation sensor

1. A rotary valve, comprising:
a motor;
a rotor shaft that is axially rotated by the motor;
a housing that accommodates the rotor shaft in an internal space thereof;
a stator fixed to the housing on a distal end side of the rotor shaft;
a rotor that is held at the distal end of the rotor shaft and rotates together with the rotor shaft;
a bearing that is interposed between an inner peripheral surface of the housing and an outer peripheral surface of the rotor shaft, supports the rotor shaft, and engages with the rotor shaft in an axial direction of the rotor shaft; and an elastic member that is provided in the internal space of the housing so as to urge the rotor shaft toward the stator side via the bearing, independently of the rotation of the rotor shaft.

2. The rotary valve according to claim 1, wherein the bearing is a ball bearing having an inner ring and an outer ring, the inner ring of the ball bearing and the rotor shaft engage in the axial direction of the rotor shaft, and the elastic member is provided so as to be in direct contact only with the outer ring of the ball bearing and urge the ball bearing toward the stator side.

3. The rotary valve according to claim 1, wherein the rotor shaft includes a protruding portion at its distal end portion that protrudes radially outward from the outer peripheral surface, and the bearing engages with the rotor shaft by contacting the protruding portion.

4. The rotary valve according to claim 1, wherein the protruding portion is a retaining ring attached to the outer peripheral surface of the rotor shaft.

5. The rotary valve according to claim 1, wherein the housing is an integral structure, and both the motor and the stator are fixed to the housing.

6. The rotary valve according to claim 5, wherein a central axis of a drive shaft of the motor and a central axis of the rotor shaft are aligned with each other.

7. The rotary valve according to claim 6, wherein a fitting structure that engages in a rotational direction by fitting with each other is provided at a distal end portion of the drive shaft of the motor and a proximal end portion of the rotor shaft, and the drive shaft of the motor and the rotor shaft engage with each other only in the rotational direction by the fitting structure.

8. The rotary valve according to claim 7, wherein the fitting structure includes a pin that penetrates the distal end portion of the drive shaft of the motor perpendicularly to an axial direction, and a groove provided in the proximal end portion of the rotor shaft into which the pin is fitted.
